(19) United States
(12) Patent Application Publication
(10) Pub. No.: US 2012/0176785 A1
(43) Pub. Date: Jul. 12, 2012

(54) STRUCTURE IMPROVEMENT OF LED LAMP

(75) Inventor: Hung-Tsung HSU, Taoyuan City (TW)

(73) Assignee: GEM-SUN TECHNOLOGIES CO., LTD.

(21) Appl. No.: 12/987,212

(22) Filed: Jan. 10, 2011

(51) Int. Cl. F21V 29/00

(52) U.S. Cl. 362/218

(57) ABSTRACT

The invention provides a LED lamp comprising a circuit board and a tube body. The circuit board has a plurality of LED chips and a first heat dissipation body connecting to each LED chip on one surface thereof. Also, the circuit board provides a through hole thereon and has a heat conductor inserting the through hole for connecting the first heat dissipation body to a second heat dissipation body on the other surface. The tube body has a hollow casing for seal packing the circuit board. The LED lamp of the invention has a heat dissipation body with large surface area and seal packing the circuit board in the tube body made of high heat conducting plastics so that it may have effect of heat dissipation and prevent from moisture and dust.

### BACKGROUND OF THE INVENTION

1. Field of the Invention

This invention generally relates to a LED lamp, and in particular to an LED lamp having heat dissipation body with large surface area.

2. Description of Prior Art

Commercial lighting, such as lighting for offices, classrooms and large exhibition center mostly uses fluorescent lamps at present. Also, the fixtures and peripheral products of fluorescent lamps have been developed well to fit fluorescent lamps. The main stream products are T5, T6 and T8 (diameter: ⅝, 6/8 and 8/8 inch respectively). The price of fluorescent lamps is not expensive, but fluorescent lamps have some drawbacks.

Fluorescent lamps are long tubes that contain mercury and argon gas. Electrodes sealed into each end of a tube allow the lamp to conduct an electric current, thereby emitting ultra-violet radiation. The inside surface of the tube is coated with a phosphor that provides visible illumination when excited by ultra-violet radiation. The tube of a fluorescent lamp is a glass envelope. The phosphor or fluorescent coating may be harmful to a person's eyes. The glass envelope is infamous for its ability to shatter and blanket an area with sharp glass. The toxicities to human being and environment associated with mercury exposure are well documented.

Additionally, fluorescent lamps provides a flash lighting rather than a stable lighting. The flicker frequency is associated with driving voltage. Although the flash lighting is not easy to notice by human visual perception, it may cause danger in some work environments due to the strobe effect. For example, a rotating machine looks like stopping when its rotating frequency is the same to the flicker frequency of fluorescent lamps. Moreover, fluorescent lamps may result in the strobe effect in a vedioshooting film.

Therefore, use of LED lamps that have plastic casing and do not use mercury and phosphor is a good alternative in light of environmental safe and work safe. However, there may have a problem to be solved when LED lamps would replace fluorescent lamps. Because the requirement of most fixtures and peripheral products is directed to fit fluorescent lamps, it is required to provide a bar circuit board into a transparent tube body with the same size to that of fluorescent lamps and a convert on the fixture for a conversion of utility (AC) power source to low pressure DC power source when using LED lamps to replace fluorescent lamps.

Under this situation, the issue of heat dissipation may perplex the skill persons in the art. Because the tube body has a confined space inside, the heat produced from LED chips that are disposed on the central position of circuit board and the related circuit may fail to release to outside effectively. The accumulative heat is liable to damage the parts of circuit board and LED chips.

A prior art of heat dissipation is to transfer heat produced from circuit board to two ends of tube body and dissipate the heat to outside by provide heat conducting material such as aluminum plate. However, the distance from the center to two ends of tube body is too long when retrofitting to the requirement of tube body of fluorescent lamps, it may cause the heat can not be discharged in time. Also, the long aluminum plate is not suitable to a normal fixture due to the consideration of weight. In addition, a casing of tube body having through holes is proposed, but the dust and moisture may easily intrude into the tube body to have a dirty, or even damaged LED. Therefore, the problem of heat dissipation of LED lamps still needs to overcome effectively.

Therefore, the inventor conducted researches according to the scientific approach in order to improve and resolve the above drawback, and finally proposed the present invention, which is reasonable and effective.

### SUMMARY OF THE INVENTION

It is an object of present invention to provide a LED lamp having a heat dissipation body with large surface area and sealing a circuit board, a LED chip disposed on the circuit board and the heat dissipation body in the tube body made of high heat conducting plastics so that it may have effect of heat dissipation and prevent from moisture and dust.

In order to achieve the above object, there is provided a LED lamp according to one aspect of the present invention, comprising a circuit board and a tube body. The circuit board has a plurality of LED chips and a first heat dissipation body connecting to each LED chip on one surface thereof. Also, the circuit board provides a through hole thereon and has a heat conductor inserting the through hole for connecting the first heat dissipation body to a second heat dissipation body on the other surface. The LED chips connect to the first heat dissipation bodies by a bonding wire, such as gold wire, silver wire or Au—Ag alloy wire. The tube body has a hollow casing. The casing is made of high heat conducting plastics and used for sealing the circuit board so that the heat in the tube body inside may be discharged and release to outside.

The LED lamp of the invention may lead the heat produced from LED chips from the first heat dissipation body to the second heat dissipation body by heat conductors to increase the whole heat dissipation area. Also, the LED lamp uses the tube body made of high heat conducting plastics for sealing the circuit board so that the heat produced from LED chips may be discharged in time and release to outside. Therefore, the LED lamp of the invention may have effect of heat dissipation and prevent from moisture and dust.

It is another aspect of the present invention to provide the first and the second heat dissipation bodies on the two sides of LED chips respectively in order to obtain a larger heat dissipation surface area for an uniform heat dissipation and preventing from heat to accumulate on the position near LED chips.

The circuit board of the present invention provides a through hole thereon and has a heat conductor, for example solder paste, inserting the through hole for connecting the first heat dissipation body on one surface to the second heat dissipation body on the other surface so that the heat produced by LED chips may be led from the first heat dissipation body to the second heat dissipation body, that is to obtain a larger heat dissipation surface area. Those excellent heat dispersion materials such as gold, copper, gold-copper alloy, aluminum or other materials having a high thermal coefficient may be suitable to use as the first and second heat dissipation bodies.

A high thermal conductive plastic is suitable to use as the casing material of the tube body, and it is preferred to select polycarbonate (PC) which is heat-resistant to about 130. The casing of the tube body may be made transparent or matt surface type. Moreover, the inner wall of casing of the tube body has a fixed unit for fixing the circuit board. The circuit board has a pair of contacts at each end thereof to connect to electrodes which are provided on conductive end cover of the two ends of casing of the tube body. The tube body is sealed and can be further processed by the vacuum.

It is yet another aspect of the present invention to provide a LED lamp, comprising a circuit board and a tube body. The circuit board has a plurality of LED chips on one surface and a plurality of LED chips on the other surface, namely, there are provided a plurality of LED chips on double surfaces of the circuit board. The arrangement of LED chips on double surfaces of the circuit board depends on the design need, for example, staggering up and down to obtain a uniform luminous LED lamp on two surfaces. The LED chips connect to the first heat dissipation bodies by a bonding wire, such as gold wire, silver wire or Au—Ag alloy wire. The tube body has a hollow casing for sealing the circuit board. A high thermal conductive plastic is suitable for the material of the casing of the tube body, and it is preferred to select polycarbonate which is heat-resistant to about 130° C.

It is a further aspect of the present invention to provide a long circuit board to fit a LED lamp with a long tube body. The long circuit board can be made by bolting, welding or riveting a plurality of regular circuit boards, for example two regular circuit boards.

In order to increase the brightness, there is provided a LED lamp having a tube body with large diameter to fit a wide circuit board according to an additional aspect of the present invention. There have plural rows of LED chips been provided on the wide circuit board in parallel, for example two rows.

The following effects may be achieved at least by the present invention. Because the LED lamp of the present invention is sealed completely, it can prevent from moisture and dust to damage LED chips. Also, the LED lamp has a casing of high heat conducting plastics so that the heat produced from LED chips may be discharged in time.

Meanwhile, because the LED lamp of the present invention has a LED chip that connects two heat dissipation bodies up and down to obtain a larger heat dissipation surface area, it can prevent from heat to accumulate on the position near LED chips and damage the LED chips.

### BRIEF DESCRIPTION OF THE DRAWINGS

FIG. 1 shows an exploded view of a LED lamp of a first preferred embodiment of according to the invention.

FIG. 2 shows a cross-sectional view of a LED chip and heat dissipation body provided on the circuit board of the first preferred embodiment of according to the invention.

FIG. 3 shows an exploded view of a LED lamp of a second preferred embodiment of according to the invention.

FIG. 4 shows an exploded view of a LED chip and heat dissipation body provided on the circuit board of a second preferred embodiment of according to the invention.

FIG. 5 shows an assembly of a LED chip and heat dissipation body provided on the circuit board of a second preferred embodiment of according to the invention.

FIG. 6 shows a top view of the arrangement of a LED chip and the first and second heat dissipation bodies provided on the circuit board of a second preferred embodiment of according to the invention.

FIG. 7 shows a cross-sectional view along line 5-5 of FIG. 6.

FIG. 8 shows a cross-sectional view of a LED lamp of a second preferred embodiment of according to the invention.

FIG. 9 shows an exploded view of a LED chip and heat dissipation body provided on the circuit board of a third preferred embodiment of according to the invention.

FIG. 10 shows an exploded view of a LED lamp of a fourth preferred embodiment of according to the invention.

FIG. 11 shows an exploded view of a LED lamp of a fifth preferred embodiment of according to the invention.

### DETAILED DESCRIPTION OF THE INVENTION

Referring now to the drawings wherein the showings are for the purpose of illustrating a preferred embodiment of the invention only and not for the purpose of limiting the same.

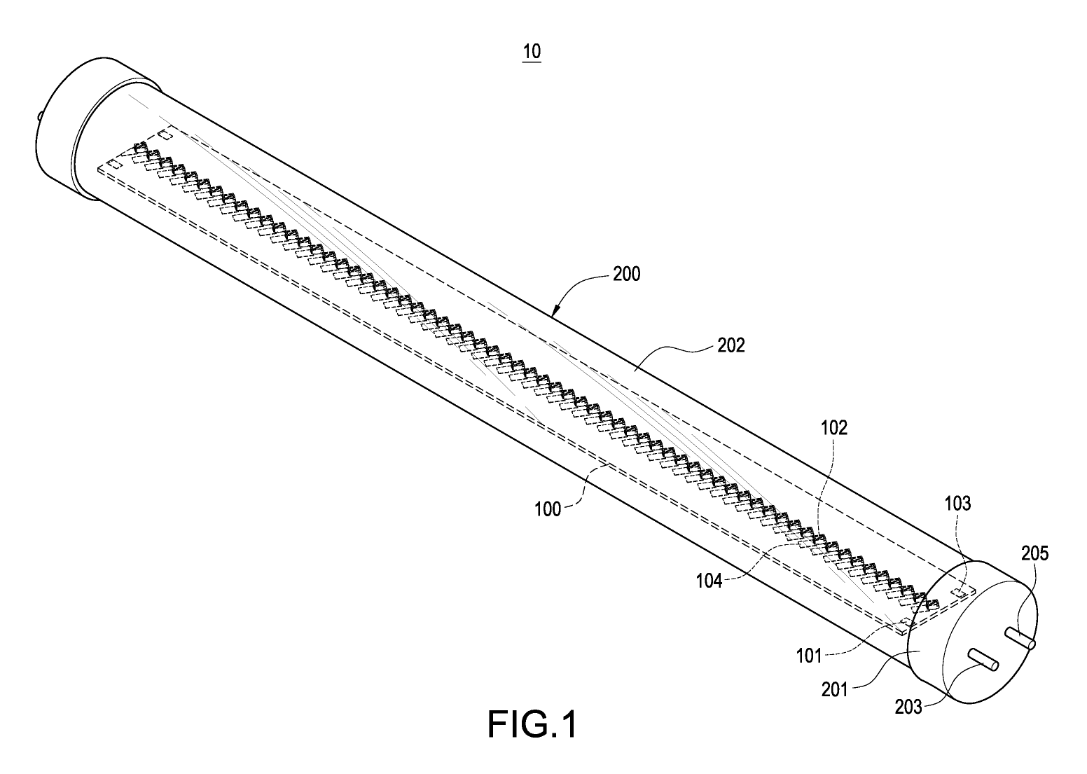

Please refer to FIG. 1. FIG. 1 shows an exploded view of a LED lamp of a first preferred embodiment of according to the invention. As shown in FIG. 1, for retrofitting the LED lamp 10 to the requirement of fixtures and peripheral products of fluorescent lamps, there is provided a bar circuit board 100 into a transparent tube body 200 with the same size to that of fluorescent lamps. Specifically, the tube body 200 has a hollow casing 202 for sealing the circuit board 100 that comprises LED chips 102 and the first heat dissipation body. A high thermal conductive plastic is suitable material for the casing 202 of the tube body 200, and it is preferred to select polycarbonate (PC) which is heat-resistant to about 130° C. The casing 202 of the tube body 200 may be made transparent or matt surface type. The circuit board 100 has a pair of contacts 101, 103 at each end thereof to connect to electrodes 203, 205 which are provided on conductive end cover 201 of the two ends of the casing 202 of the tube body 200. The tube body 200 is sealed and can be further processed by a vacuuming procedure.

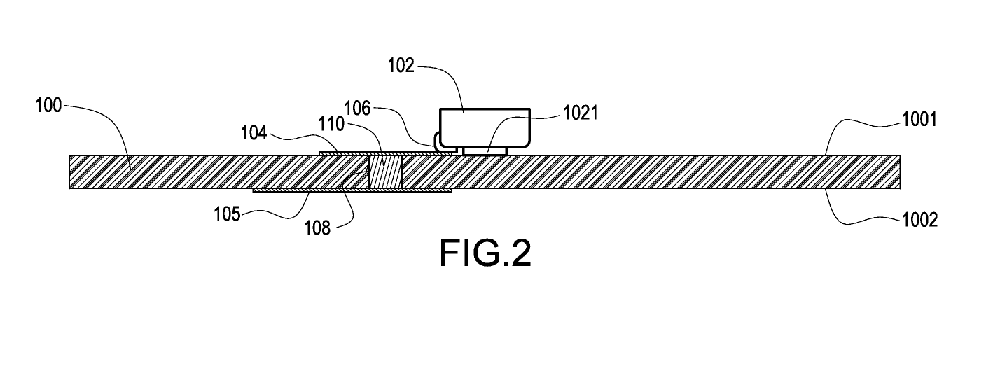

Next, please refer to FIG. 2. FIG. 2 shows a cross-sectional view of an LED chip and heat dissipation body provided on the circuit board of the first preferred embodiment of according to the invention. As shown in FIG. 2, the circuit board 100 has the LED chip 102 on one surface 1001 connecting to the first heat dissipation body 104 by a bonding wire 106, and the LED chip 102 electrically connects to the circuit board 100 by the contact 1021 on the bottom. When electric current forward passes the p-n junction of LED chip 102, the glow may emit from LED chip. The bonding wire 106 may be gold wire, silver wire or Au—Ag alloy wire.

Also, The circuit board 100 provides a through hole 108 thereon and has a heat conductor 110, for example solder paste, inserting the through hole 108 for connecting the first heat dissipation body 104 on one surface 1001 to the second heat dissipation body 105 on the other surface 1002 so that the heat produced by LED chips 102 may be led from the bonding wire 106 and the first heat dissipation body 104 to the second heat dissipation body 105. Those excellent heat dispersion materials such as gold, copper, gold-copper alloy, aluminum or other materials having a high thermal coefficient may be suitable to use as the first and second heat dissipation bodies 104, 105.

The first and second heat dissipation bodies 104, 105 use the heat conductor 110 connecting each other to expand the heat conductive surface area by heat conduction. Also, the surface area of the first and second heat dissipation bodies 104, 105 may increase to a maximum to obtain a maximum heat dissipation surface area by adjusting the position of the first and second heat dissipation bodies 104, 105 provided on the circuit board 100. Accordingly, the heat produced from LED chips 102 does not accumulate on the position near LED chips. Furthermore, the material of the casing 202 of the tube body 200 is selected from high thermal conductive plastics such as polycarbonate so that the heat existed in the internal space of the tube body 200 may be discharged in time and release to outside.

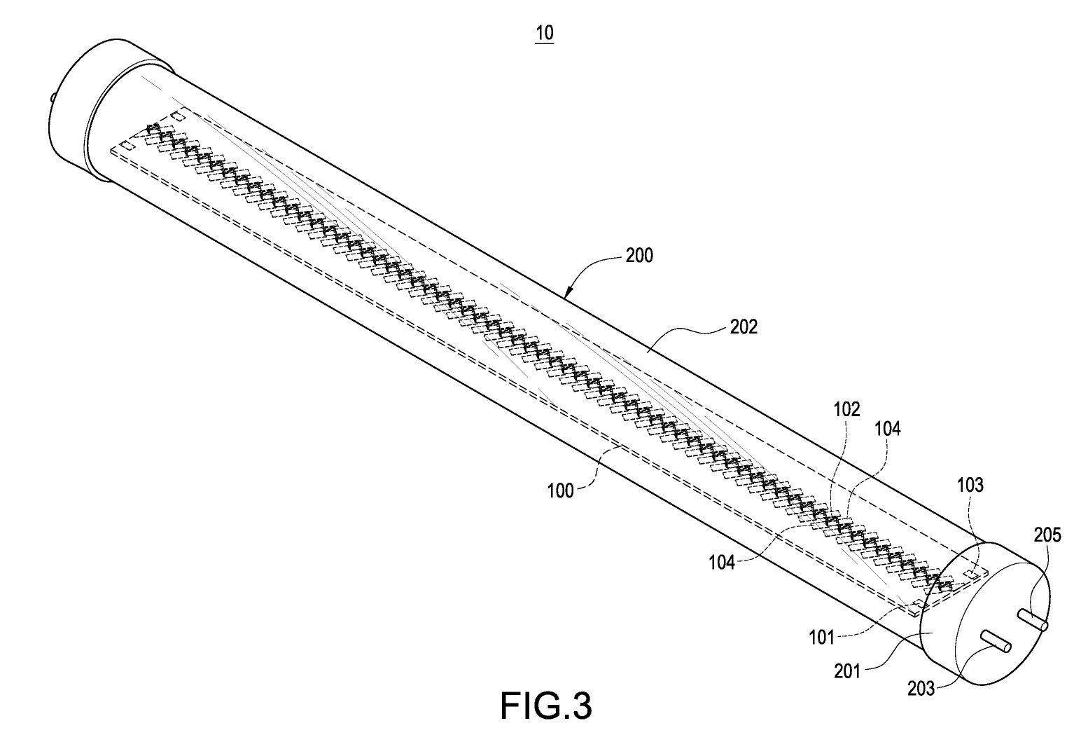

Next, please refer to FIG. 3. FIG. 3 shows an exploded view of an LED lamp of a second preferred embodiment of according to the invention. The difference between FIG. 3 and FIG. 1 is that the LED chip 102 provided on the circuit board 100 of the LED lamp 10 has the first heat dissipation body 104 and second heat dissipation body (not shown in FIG. 3) at two sides. Except for the above difference, the others are the same, for example, the circuit board 100 also has a pair of contacts 101, 103 at each end thereof to connect to electrodes 203, 205 which are provided on conductive end cover 201 of the two ends of the casing 202 of the tube body 200. When using the LED lamp 10 of the invention, the electric current is inputted into the LED chip 102 by connecting external power source (not shown in FIG. 3) to electrodes 203, 205 which are provided on conductive end cover 201 of the two ends of the casing 202 of the tube body 200, the glow may emit from the LED lamp 10.

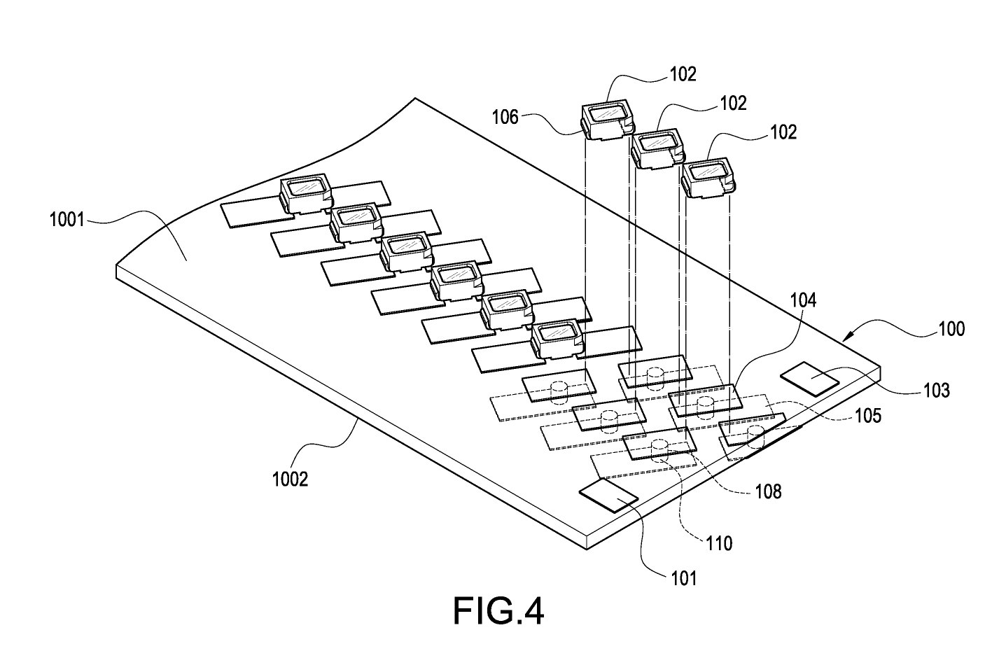

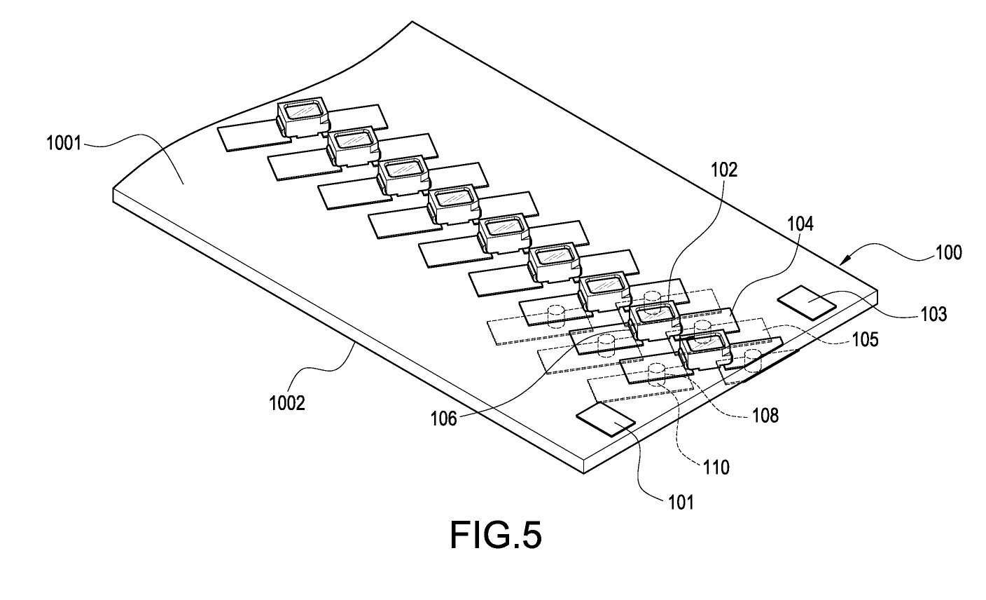

Next, please refer to FIG. 4 and FIG. 5. FIG. 4 shows an exploded view of a LED chip and heat dissipation body provided on the circuit board of a second preferred embodiment of according to the invention. FIG. 5 shows an assembly of a LED chip and heat dissipation body provided on the circuit board of a second preferred embodiment of according to the invention. As shown in the drawings, the circuit board 100 has a plurality of LED chips 102 arranged on one surface 1001 and connecting to the first heat dissipation body 104 provided at two sides of the LED chips 102 by a bonding wire 106 at two ends on the bottom of the LED chip 102. The bonding wire 106 may be gold wire, silver wire or Au—Ag alloy wire.

Also, the circuit board 100 has a through hole 108 thereon and has a heat conductor 110, for example solder paste, inserting the through hole 108 for connecting the first heat dissipation body 104 on one surface 1001 of the circuit board 100 to the second heat dissipation body 105 on another surface 1002 of circuit board 100. Those excellent heat dispersion materials such as gold, copper, gold-copper alloy, aluminum or other materials having a high thermal coefficient may be suitable to use as the first and second heat dissipation bodies 104, 105.

Because there is provided the heat conductor 110 inserting into the through hole 108 of the circuit board 100, the heat produced by LED chips 102 may be led from the bonding wire 106 and the first heat dissipation body 104 to the second heat dissipation body 105 in order to expand the heat conductive surface area by heat conduction. Also, the surface area of the first and second heat dissipation bodies 104, 105 may increase to a maximum to obtain a maximum heat dissipation surface area by adjusting the position of the first and second heat dissipation bodies 104, 105 provided on the circuit board 100. In addition, because the LED chip 102 has the first heat dissipation body 104 and second heat dissipation body 105 at two sides thereof, it can further expand heat dissipation surface area.

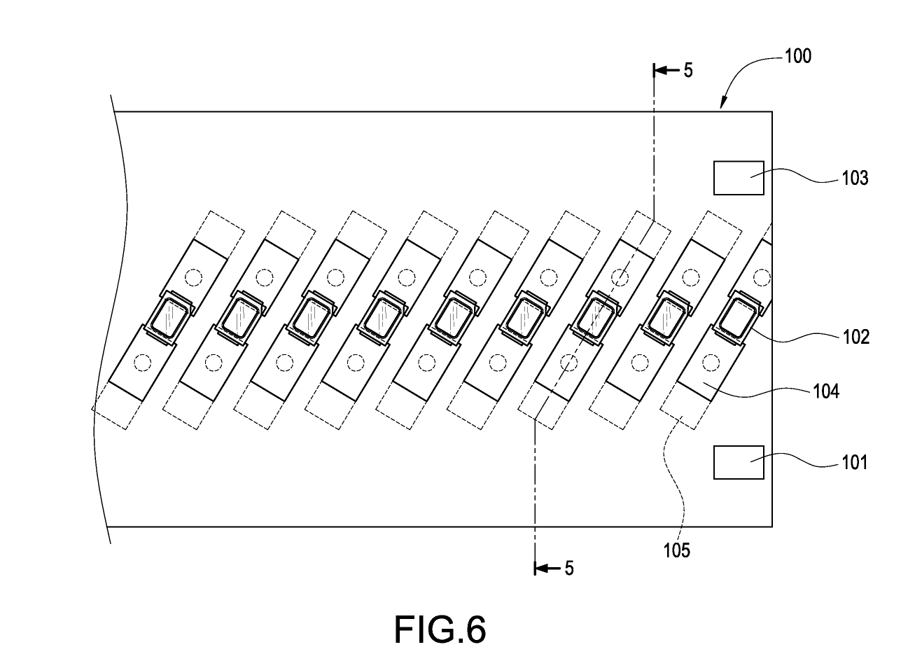

Next, please refer to FIG. 6. FIG. 6 shows a top view of the arrangement of a LED chip and the first and second heat dissipation bodies provided on the circuit board of a second preferred embodiment of according to the invention. As the LED chip 102 and the first and second heat dissipation bodies 104, 105 are provided on the circuit board 100 in bevel angle arrangement, it can provide a longer distance to the edge of the circuit board 100 for mounting the first and second heat dissipation bodies 104, 105 with a large surface area than the arrangement in right angle. Accordingly, the surface area of the first and second heat dissipation bodies 104, 105 may increase to a maximum to obtain a maximum heat dissipation surface area. Therefore, the heat produced from LED chips 102 does not accumulate on the position near LED chips, and can conduct to the first and second heat dissipation bodies 104, 105 in time, and the heat existed in the internal space of the tube body (not shown in FIG. 6) may be discharged and released to outside through the high thermal conductive plastic tube body of the invention.

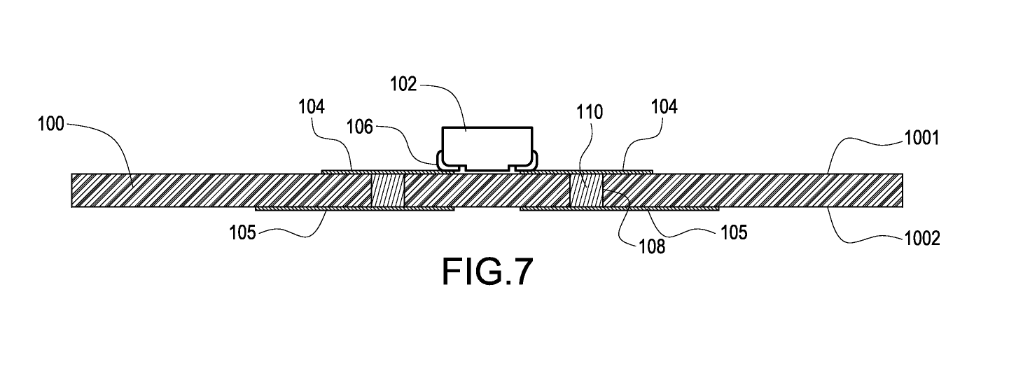

Next, please refer to FIG. 7. FIG. 7 shows a cross-sectional view along line 5-5 of FIG. 6. As shown in FIG. 7, the LED chip 102 provided on one surface 1001 of the circuit board 100 has bonding wires 106 at two ends on the bottom, respectively connecting to the first heat dissipation bodies 104, 104 provided on the LED chip 102 at two sides.

Also, there is provided a through hole 108 on the circuit board 100 at the position which is covered by the first heat dissipation body 104, and has a heat conductor 110, for example solder paste, inserting the through hole 108 for connecting the first heat dissipation body 104 on one surface 1001 of the circuit board 100 to the second heat dissipation body 105 on another surface 1002 of circuit board 100 so that the heat produced by LED chips 102 may be led from the bonding wire 106 and the first heat dissipation body 104 to the second heat dissipation body 105.

There is provided the heat conductor 110 for connecting the first heat dissipation body 104 and the second heat dissipation body to expand the heat dissipation surface area by heat conduction so that the heat produced by LED chips 102 may be led from the bonding wire 106 and the first heat dissipation body 104 to the second heat dissipation body 105 in order to expand the heat dissipation surface area.

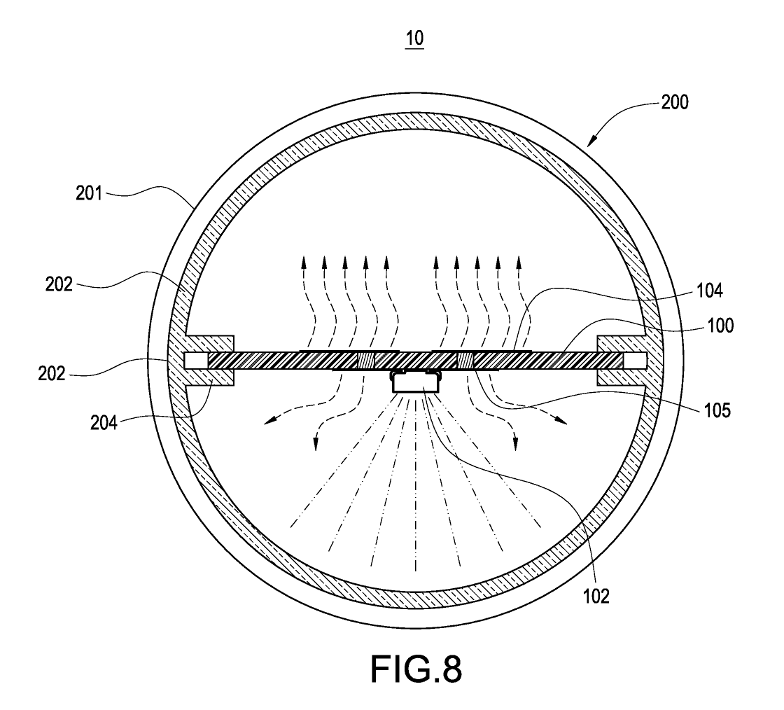

Next, please refer to FIG. 8. FIG. 8 shows a cross-sectional view of a LED lamp of a second preferred embodiment of according to the invention. As shown in the drawings, the casing 202 of the tube body 200 of the LED lamp 10 has the material of polycarbonate with highly transparent or matt surface type. Moreover, the inner wall of the casing 202 of the tube body 200 has a fixed unit 204 for fixing the circuit board 100. The tube body 200 further comprises two conductive end covers 201, 201 respectively fixing on the two ends of the casing 202 of the tube body 200. The tube body is sealed and can be further processed by the vacuum. In FIG. 8, the dashed line indicates the two directions of heat dissipation, wherein the heat is produced from LED chip provided on the circuit board 100 to the first and second heat dissipation bodies 104, 105. The dash-dotted line indicates the ray emitted from the LED chip 102.

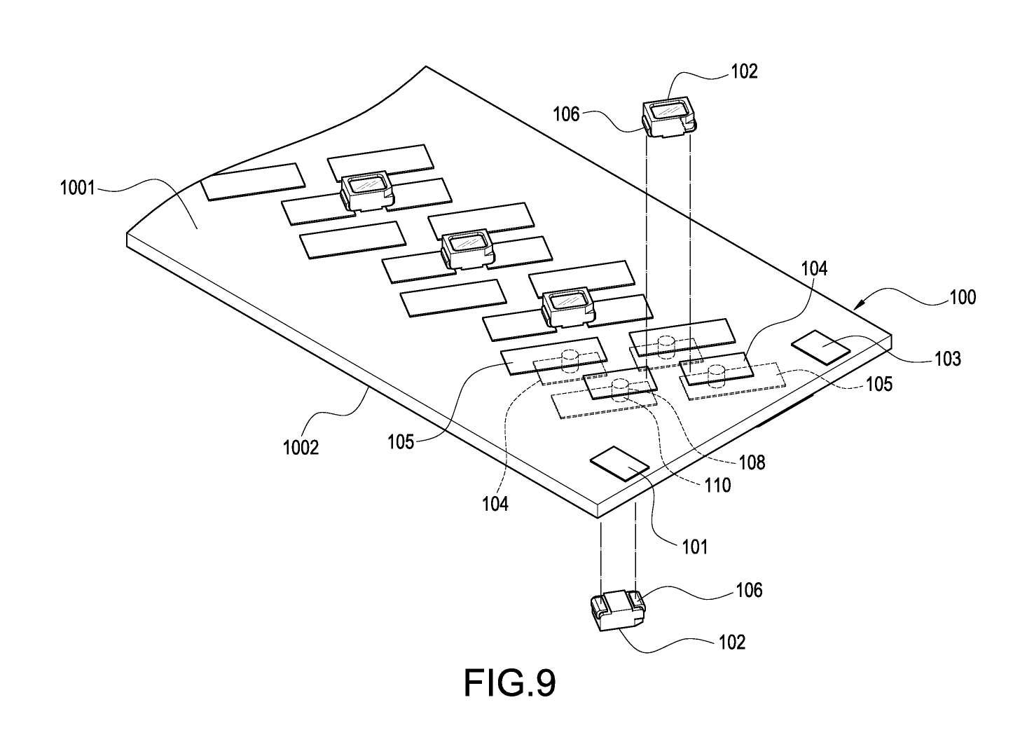

Next, please refer to FIG. 9. FIG. 9 shows an exploded view of an LED chip and heat dissipation body provided on the circuit board of a third preferred embodiment of according to the invention. As shown in the drawings, The circuit board 100 has a plurality of LED chips 102 on one surface 1001 and a plurality of LED chips 102 on the other surface 1002, namely, there are provided a plurality of LED chips 102 on double surfaces of the circuit board 100. The arrangement of LED chips 102 on double surfaces 1001, 1002 of the circuit board 100 depends on the design need, for example, staggering in up-and-down direction. Accordingly, there are provided a plurality of LED chips 102 on double surfaces of the circuit board 100 to obtain a uniform luminous LED lamp (not shown in FIG. 9) on two surfaces.

Further, the circuit board 100 has a plurality of LED chips 102 arranged on one surface 1001 and connecting to the first heat dissipation body 104 provided at two sides of the LED chips 102 by a bonding wire 106 at two ends on the bottom of the LED chip 102. The bonding wire 106 may be gold wire, silver wire or Au—Ag alloy wire.

Also, there is provided a through hole 108 on the circuit board 100 at the position which is covered by the first heat dissipation body 104, and has a heat conductor 110, for example solder paste, inserting the through hole 108 for connecting the first heat dissipation body 104 on one surface 1001 of the circuit board 100 to the second heat dissipation body 105 on another surface 1002 of circuit board 100 so that the heat produced by LED chips 102 may be led from the bonding wire 106 and the first heat dissipation body 104 to the second heat dissipation body 105. Those excellent heat dispersion materials such as gold, copper, gold-copper alloy, aluminum or other materials having a high thermal coefficient may be suitable to use as the first and second heat dissipation bodies 104, 105.

There is provided the heat conductor 110 for connecting the first heat dissipation body 104 and the second heat dissipation body to expand the heat dissipation surface area by heat conduction so that the heat produced by LED chips 102 may be led from the bonding wire 106 and the first heat dissipation body 104 to the second heat dissipation body 105 in order to expand the heat dissipation surface area. Therefore, the heat produced from LED chips 102 does not accumulate on the position near LED chips 102, and can conduct to the first and second heat dissipation bodies 104, 105 in time, and the heat existed in the internal space of the tube body (not shown in FIG. 6) may be discharged and released to outside through the high thermal conductive plastic tube body of the invention.

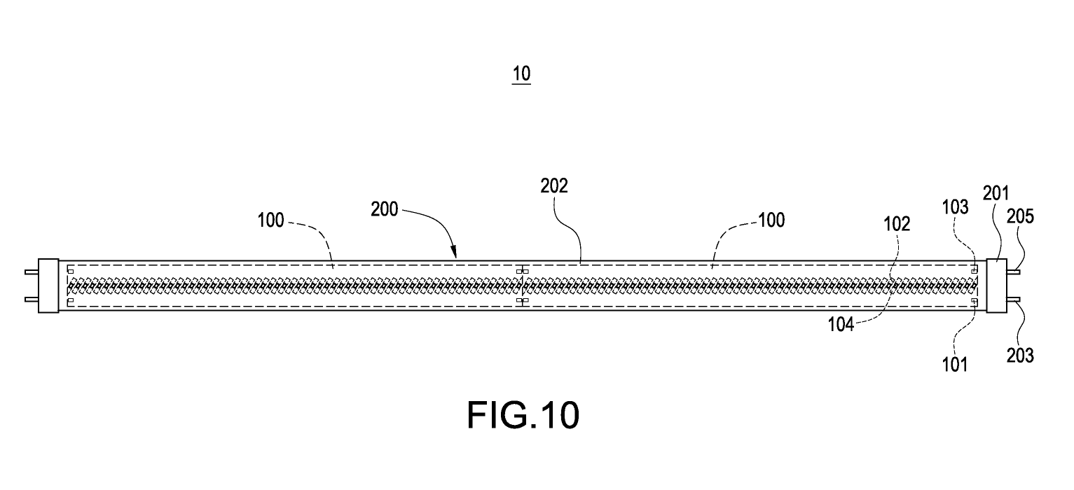

Next, please refer to FIG. 10. FIG. 10 shows an exploded view of a LED lamp of a fourth preferred embodiment of according to the invention. As shown in FIG. 10, there is provided a long circuit board to fit a LED lamp 10 with a long tube body. The long circuit board can be made by bolting, welding or riveting a plurality of regular circuit boards 100, for example two regular circuit boards 100. The casing 202 of the tube body 200 of the LED lamp 10 has the material of polycarbonate with highly transparent or matt surface type. The tube body 200 further comprises two conductive end covers 201, 201 respectively fixing on the two ends of the casing 202 of the tube body 200. The LED chip 102 provided on the circuit board 100 of the LED lamp 10 has the first heat dissipation body 104 and second heat dissipation body (not shown in FIG. 10) at two sides. The circuit board 100 also has a pair of contacts 101, 103 at each end thereof to connect to electrodes 203, 205 which are provided on conductive end cover 201 of the two ends of the casing 202 of the tube body 200. When using the LED lamp 10 of the invention, the electric current is inputted into the LED chip 102 by connecting external power source (not shown in FIG. 10) to electrodes 203, 205 which are provided on conductive end cover 201 of the two ends of the casing 202 of the tube body 200, the glow may emit from the LED lamp 10.

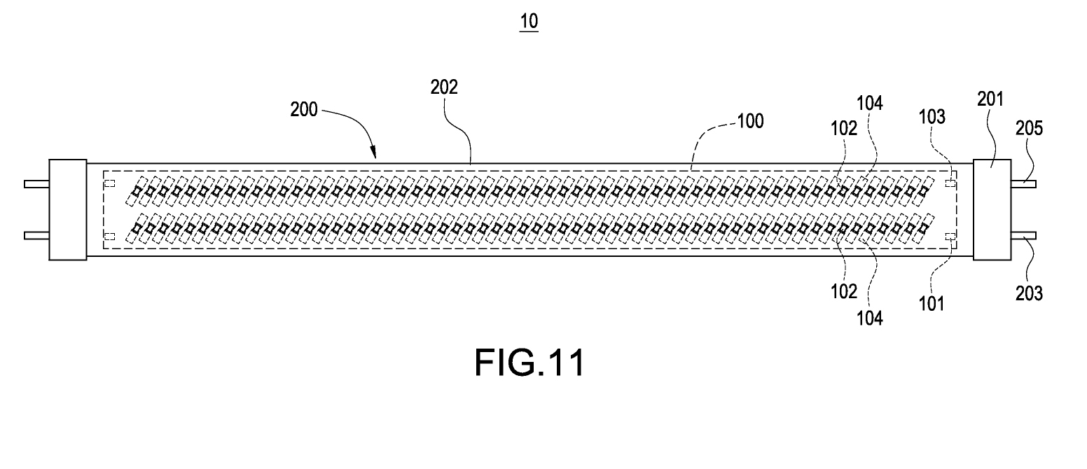

Next, please refer to FIG. 11. FIG. 11 shows an exploded view of a LED lamp of a fifth preferred embodiment of according to the invention. As shown in FIG. 11, in order to increase the brightness, there is provided an LED lamp 10 having a tube body with large diameter to fit a wide circuit board 100. There have plural rows of LED chips 102 been provided on the wide circuit board 100 in parallel, for example two rows. The casing 202 of the tube body 200 of the LED lamp 10 has the material of polycarbonate with highly transparent or matt surface type. The tube body 200 further comprises two conductive end covers 201, 201 respectively fixing on the two ends of the casing 202 of the tube body 200. The LED chip 102 provided on the circuit board 100 of the LED lamp 10 has the first heat dissipation body 104 and second heat dissipation body (not shown in FIG. 11) at two sides. The circuit board 100 also has a pair of contacts 101, 103 at each end thereof to connect to electrodes 203, 205 which are provided on conductive end cover 201 of the two ends of the casing 202 of the tube body 200. When using the LED lamp 10 of the invention, the electric current is inputted into the LED chip 102 by connecting external power source (not shown in FIG. 11) to electrodes 203, 205 which are provided on conductive end cover 201 of the two ends of the casing 202 of the tube body 200, the glow may emit from the LED lamp 10.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An light emitting diode (LED) lamp, comprising
a circuit board having a plurality of LED chips on one surface of the circuit board, a first heat dissipation body connecting to each LED chip, and a through hole provided on the circuit board, the circuit board having a heat conductor inserting the through hole for connecting the first heat dissipation body to a second heat dissipation body on the other surface of the circuit board; and
a tube body having a hollow casing for sealing the circuit board.

2. The LED lamp as claimed in claim 1, wherein the LED chip has the first and the second heat dissipation bodies on two sides respectively.

3. The LED lamp as claimed in claim 1, wherein the heat conductor is solder paste.

4. The LED lamp as claimed in claim 1, wherein the first and the second heat dissipation bodies have the material of gold, copper, gold-copper alloy or aluminum.

5. The LED lamp as claimed in claim 1, wherein the LED chip connects to the first heat dissipation body by a gold wire, silver wire or Au—Ag alloy wire.

6. The LED lamp as claimed in claim 1, wherein the LED chips are provided on the circuit board in bevel angle arrangement.

7. The LED lamp as claimed in claim 1, wherein the casing of the tube body has the material of polycarbonate with transparent or matt surface type.

8. The LED lamp as claimed in claim 1, wherein the circuit board has a pair of contacts at each end thereof.

9. The LED lamp as claimed in claim 1, wherein the circuit boards connects each other by bolting, welding or riveting.

10. The LED lamp as claimed in claim 1, wherein the LED chips are provided on the circuit board in parallel rows.

11. An light emitting diode (LED) lamp, comprising
a circuit board having a plurality of LED chips on an upper surface and a lower surface thereof, each LED chip provided on the upper surface connecting to a first heat dissipation body on the upper surface, and a through hole provided on the circuit board, the circuit board having a heat conductor inserting the through hole for connecting the first heat dissipation body to a second heat dissipation body on the lower surface, each LED chip provided on the lower surface connecting to the first heat dissipation body on the lower surface, and the through hole provided on the circuit board, the circuit board having the heat conductor inserting the through hole for connecting the first heat dissipation body to a second heat dissipation body on the upper surface; and
a tube body having a hollow casing for sealing the circuit board.

12. The LED lamp as claimed in claim 11, wherein the LED chip has the first and the second heat dissipation bodies on two sides respectively.

13. The LED lamp as claimed in claim 11, wherein the circuit board provided a plurality of LED chips on two surfaces is staggering up and down.

14. The LED lamp as claimed in claim 11, wherein the heat conductor is solder paste.

15. The LED lamp as claimed in claim 11, wherein the first and the second heat dissipation bodies have the material of gold, copper, gold-copper alloy or aluminum.

16. The LED lamp as claimed in claim 11, wherein the LED chip connects to the first heat dissipation body by a gold wire, silver wire or Au—Ag alloy wire.

17. The LED lamp as claimed in claim 11, wherein the LED chips are provided on the circuit board in bevel angle arrangement.

18. The LED lamp as claimed in claim 11, wherein the casing of the tube body has the material of polycarbonate with transparent or matt surface type.

19. The LED lamp as claimed in claim 11, wherein the circuit boards connects each other by bolting, welding or riveting.

20. The LED lamp as claimed in claim 11, wherein the LED chips are provided on the circuit board in parallel rows.
